(19) United States
(12) Patent Application Publication
(10) Pub. No.: US 2006/0109125 A1
(43) Pub. Date: May 25, 2006

(54) System for RF detection and location determination of merchandising materials in retail environments

(75) Inventors: Gary L. Overhultz, River Forest, IL (US); Gordon E. Hardman, Boulder, CO (US); John W. Pyne, Erie, CO (US)

Correspondence Address: JONES DAY, 77 WEST WACKER, CHICAGO, IL, 60601-1692, US

(73) Assignee: Goliath Solutions LLC., Deerfield, IL (US)

(21) Appl. No.: 11/253,256

(22) Filed: Oct. 18, 2005

Related U.S. Application Data
(60) Provisional application No. 60/625,723, filed on Nov. 8, 2004.

(51) Int. Cl. G08B 13/14; H04Q 5/22; G08B 25/00

(52) U.S. Cl. 340/572.1; 340/10.1; 340/524

(57) ABSTRACT

A system and method for using a plurality of spaced receiver/transmitters controlled by a centralized BRT that includes a programmable device for selecting successive pairs of receiver/transmitters for interrogating at least some RF tags associated with respective objects in a given area, receiving responses from the interrogated RF tags, and sending the received response data to the centralized BRT for analysis.

This application claims the benefit of Provisional Application Ser. No. 60/625,723 filed Nov. 5, 2004. It also is a continuation-in-part of PCT application Ser. No. ______, entitled DISTRIBUTED ANTENNA ARRAY WITH CENTRALIZED DATA HUB FOR DETERMINING PRESENCE AND LOCATION OF RF TAGS, designating the U.S. as one of the countries filed on the same date hereof.

### BACKGROUND OF THE INVENTION

1. Field of the Invention

The present invention relates in general to automatic monitoring of retail conditions and in particular to an improved low-cost RF system for approach to detection and location determination of merchandising and advertising materials in retail facilities using RF tags.

2. Background of the Invention

Widespread deployment of retail monitoring technology as set forth in commonly assigned Provisional Patent Application Ser. No. 60/625,723 filed Nov. 5, 2004, and commonly assigned and published co-pending patent application Ser. No. 10/665,540, published as 2004/0056091, both of which are incorporated herein by reference, requires minimized infrastructure cost. The system disclosed therein includes long-range RF tags, readers, and a hub system capable of detecting and reporting tag locations and other information at distances of over 100 feet.

Three components form the existing system: Semi-passive tags, Backscatter Reader Transceivers (BRT's), and a Hub. Each BRT is a fully self-contained, battery operated, three antennae device. Two medium-gain patch antennas are used to read the tags, and a whip antenna is used to report the data over a wireless link to the Hub. The major components of a BRT are: (1) backscatter transmitter, (2) backscatter receiver, (3) data relay transmitter, (4) command receiver, and (5) digital processing electronics such as a micro-controller and a Complex Programmable Logic Device (CPLD).

The Hub may contain a higher-end microcomputer module, a data relay receiver, and a 2-way pager modem (or other telephonic modem equipment). Each Hub has two whip-antennas, one to receive the BRT data relay packets, and one to communicate with a pager network. Phone or LAN connections may be substituted for the pager network.

This architecture is robust and flexible. When used in small retail environments or environments with remote or disparate zones, it is also quite economical. However, radiating adequate power to cover large areas with only one transmit antennas per BRT results in several BRT's being required per store. Further, overlap in read zones can be helpful in locating tags in some configurations; however, multiple BRT's detecting the same tag may increase the difficulty in determining that tag's location in a particular sub-section of the facility.

For example, a typical facility may have a number of zones for placement of merchandising displays, signs, and other materials. The present implementation requires many readers to cover a moderate-sized retail facility. In this configuration, cost is associated with redundancy in electronics and antennas. Further, the presence of many BRT's makes maintenance and upgrades difficult, time-consuming, and expensive.

A lower-cost approach is desirable and can be obtained with a system that centralizes the reader/transmitter electronics, and distributes the required RF signals over coaxial cables to and from antennas. Such an approach will allow improved functionality at a significantly lower cost. At the reduced cost, such a system would rival the cost pinch-point approach that attempts to tell when displays move into or out of the sales area based on detection at the intersection of backrooms and selling areas. Questions of when displays pass through such intersections almost always lead to concerns about when and where they were placed. Most CPG (Consumer Packaged Goods) retailers and manufacturers know that a bad display in a good location usually outperforms a good display in a bad location. Early data shows substantial variance in placement and the value of placement across stores, product categories, and promotional programs. If this variance can be understood and managed on an ongoing basis at a reasonable price, both CPG manufacturers and retailers will have a valuable tool for maximizing sales.

For environments with many adjacent zones (e.g. coverage of a whole facility), there is an opportunity to produce a multi-zone monitoring solution that reduces or eliminates recurring or redundant electronics costs. The present invention greatly reduces the cost of the system by centralizing electronics and distributing the Radio Frequency (RF) to zones in stores through fewer antennas.

### SUMMARY OF THE INVENTION

The present invention reduces system cost by utilizing a single BRT/Hub (“Spider”), also known as a Main Electronic Unit (MEU), with antennas attached through cables to multiple transmit and receive ports (“Web”) to cover an entire facility. Redundant electronic components normally associated with several BRT's are thereby eliminated. A single Spider may be sufficient to cover small- or medium-format facilities. Large-format facilities can be covered by a small number of Spiders that may operate independently or be linked. The Spider may be connected to AC power to eliminate cost and maintenance of batteries and allow more read cycles, if desired. Such a system could also permit substantially higher transmit wattage to be used without concern for battery life, if desired, potentially increasing the size and reliability of detection zones.

The present invention also eliminates the need for separate receive and transmit (TX and TR) units. Each Transmit/Receive (TRX) antenna unit is coupled to a respective port associated with the MEU via coaxial cable and can function as either a transmit unit or a receive unit. In one embodiment, DTMF (Dual Tone Multi Frequency) signals from a programmable unit in the MEU are sent from the MEU to selected TRX ports to enable one particular TRX to operate as a transmitter (TX) at a given point in time and to enable one other particular unit to operate as the receiver (RX). Thus, only one transmitting unit and one receiving unit are active at any instant. By having a plurality of spaced TRX units, each of which may alternately operate as both a transmit unit or a receive unit, a smaller number of antennas is required to cover the zones in a facility. Using fewer antennas to cover a given zone makes it more affordable to increase the number of zones covered. Having smaller zones allows RF power radiating from the transmit units to be decreased, thereby reducing the chances of interference with other RF applications within the facility. Further, the ability to reliably assess tag location is increased through smaller zones associated with each antenna.

Thus, it is an object of the present invention to provide a system for reducing the cost of monitoring facilities by centralizing electronics and distributing the RF signals to zones in a given facility in a manner that reduces the expense of recurring electronic components and antennas.

It is a further object of the present invention to provide a system for monitoring advertising compliance within a facility through the use of a single BRT/Hub circuit (Main Electronics Unit—MEU) and a plurality of spaced remote antennas each of which can both receive and transmit RF signals (TRX) and each of which is preferably connected to the MEU by a coaxial cable.

It is yet another object of the present invention to include a microprocessor in the MEU that can be programmed to select only one first remote TRX to transmit interrogation signals to at least some RF tags and only one second remote TRX to receive RF tag signals responding to the interrogation signals from the first remote TRX, The receiving TRX antenna transmits the RF response data to the MEU preferably via coaxial cables.

It is still another object of the present invention to provide a high power amplifier in the TX portion (transmitter) of each TRX unit to recover coaxial cable signal attenuation and a band-pass filter in each TRX unit to reduce noise and/or harmonics.

It is also an object of the present invention to set the transmitter gain of a TRX unit simultaneously with the command to operate in the transmit mode. Successively decreasing or increasing transmit power and noting the transmit power associated with a given tag read permits improved location determination. Since RF energy from a transmitter falls off with the square of the distance to the tag, and again with the square of the distance from the tag to the receive antenna, lower power reads tend to be associated with tags more proximal to a receive antenna.

It is yet another object of the present invention to select a product sale facility where the RF tags are to be placed and to associate a particular object, such as a product display, sign, and merchandising or advertising material with each RF tag such that the RF tag can confirm the existence and location of the object.

It is still another object of the present invention to provide a microprocessor and a programmable circuit that automatically selects successive pairs of only one TRX unit for transmitting interrogation signals to at least one RF tag and only one other TRX unit for receiving RF tag responses to the interrogation signals until all RF tags in the product sale facility have been interrogated.

It is another object of the present invention to provide a frequency hopping device that repetitively scans each successive selected pair of TRX's over a plurality of frequencies to increase the ability to detect response signals from the RF tags.

It is also an object of the present invention to successively scan each selected pair of TRX units with a plurality of signal power levels to increase the system ability to determine the location of the RF tags.

It is a further object of the present invention to use a received signal strength indicator (RSSI) either in addition to or in lieu of successive power levels to increase the ability to determine the location of the RF tags within the facility.

Thus, the invention relates to an improved system for monitoring retail sales comprising a plurality of RF tags dispersed in zones in a selected facility, each of the RF tags being associated with a particular object; at least one main electronic unit (MEU) associated with the selected facility for enabling monitoring of the RF tags in all of the given zones; a plurality of antenna ports electronically coupled to the MEU; at least one first transmit/receive (TRX) unit for transmitting RF signals to at last a portion of the RF tags located in at least one given zone; at least one second TRX unit located in each given zone for receiving at least some of the RF tag responses to the transmitted RF signals; each TRX unit being coupled to a respective one of the plurality of MEU antenna ports; and programmable selection means associated with the MEU to command only one TRX unit to transmit interrogation signals to RF tags in one of the given zones of the selected facility and to command only one TRX unit to receive responses to the transmitted interrogation signals from the RF tags at any given instant in time and to couple the tag responses to the MEU.

The invention also relates to a method of using a plurality of RF tags, each of which is associated with one of a like plurality of objects in a selected facility, to determine the presence of the objects comprising the steps of: placing a sufficient number of TRX (transmit/receive) units in the facility to interrogate all RF tags in the facility and to receive responses from all RF tags in the facility; selecting only one pair of TRX units at a time, one to interrogate at least some RF tags in the facility and one to receive responses from the interrogated tags; and successively selecting predetermined pairs of TRX units until all RF tags in the selected facility have been interrogated and a response received.

### BRIEF DESCRIPTION OF THE DRAWINGS

These and other more detailed objects of the present invention will be more fully disclosed when taken in conjunction with the following DETAILED DESCRIPTION OF THE DRAWINGS in which like numerals represent like elements and in which:

FIG. 1 is a schematic representation of one embodiment of the present invention;

FIG. 2 is a schematic representation of an enhanced second embodiment of the present invention;

FIG. 3 illustrates the schematic representation of FIG. 2 when one pair of TRX units has been selected to detect RF tags in at least one given zone of a facility;

FIG. 4 illustrates the schematic embodiment of FIG. 2 in which a different pair of TRX units has been selected to detect RF tags in at least one other given zone of the facility;

FIG. 5 illustrates a functional block diagram of the main electronic unit (MEU) that controls the plurality of TRX units;

FIG. 6 is a schematic representation of one of the TRX units;

FIG. 7 is an electrical block diagram representing the TRX unit of FIG. 6;

FIG. 8 is an electrical block diagram of the TRX controller shown in FIG. 6;

FIG. 9 is an electrical block diagram of the high power amplifier (HPA) of the TRX unit shown in FIG. 6; and

FIG. 10 is an electrical block diagram of the low noise amplifier (LPA) of the TRX unit shown in FIG. 6.

### DETAILED DESCRIPTION OF THE DRAWINGS

In one system that was tested, four TX ports and sixteen RX ports were selectable by a centralized BRT system through an RS232 port. RF tags were easily detected and reported with this configuration. However, one of the problems encountered was location determination of the RF tags. With self-contained battery operated readers, tags were commonly detected within the read zone of the reader. Transmitter power diversity and statistical accounting helped determine where the tags were actually located within the store. Determining tag location could be improved if transmitter power is increased and quadrafiler helix transmit antennas are used. However, if transmission power is increased, tags are detected from all over the store from unlikely combinations of Tx and Rx pairs. While the use of RSSI (Received Signal Strength Indicator) and location determination algorithms helped, it became apparent that some of the previous location detection capability was lost when going from discrete separate readers to the centralized BRT system. It was found from the above that the centralized reader approach is more economical to field than separate self-contained readers. However, the separate reader approach made location determination easier. Therefore a hybrid solution of the two architectures was conceived to obtain the present invention.

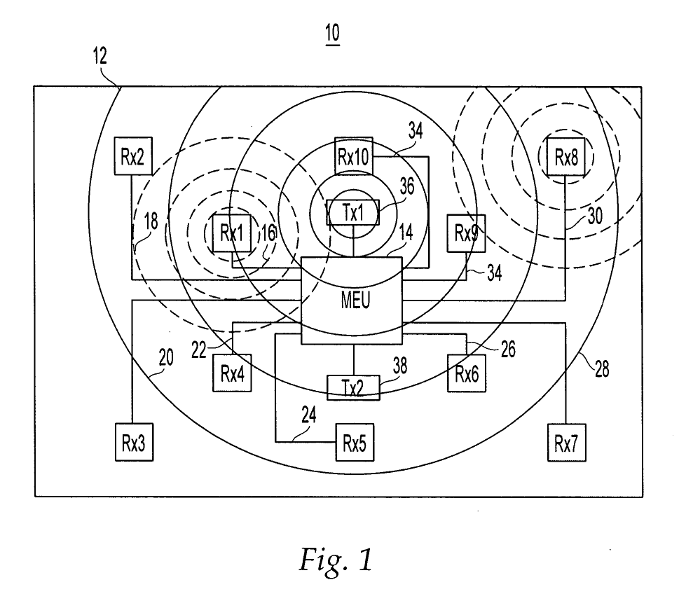

FIG. 1 is a schematic block diagram representing one embodiment (spider) 10 of the invention. This embodiment, with the use of separate RF receiving units has already been disclosed in commonly assigned copending provisional patent application No. 60/625,723 filed Nov. 5, 2004, the subjects matter of which is incorporated herein in full. A designated area 12 of a facility contains a plurality of zones represented by backscatter receivers Rx1-Rx10. Transmitters Tx1 and Tx2 (ports) are used to illuminate RF tags in a given zone. The RF tag responsive signals are received by the receivers Rx1-Rx10. The single MEU 14 is used to cover an entire store, such as a drug store, as well as a sizable portion of grocery and mass merchandising stores. Entire grocery and mass merchandising stores could be covered by a small number of spiders. Only one Tx unit and one Rx unit are active at any one time. The MEU 14 (Spider) scans a given pair of Tx/Rx units over 51 channels for successive multiple power levels until all Tx/Rx unit pairs have been covered. For example, only Tx1 and Rx1 are enabled. In such case, Tx1 illuminates RF tags in range and only Rx1 receives the RF tag response. Tx1 and Rx1 are successively scanned at multiple frequencies and multiple power levels. The RF signals are coupled to and from the Tx/Rx units and the MEU 14 by coaxial cables 16-34.

The MEU 14 could then scan a different zone using Tx1 and Rx2, for example, or Tx1 and Rx8. This process is repeated until all zones are interrogated. It should be noted that Rx1-Rx10 can be the receiver portions of TRX1-TRX10 and are selected by the MEU 14. Further, Tx1 36 and Tx2 38 can be the selected transmitter units with the MEU designating only the transmitter portion Tx of both units 36,38 to be active. Thus, in this embodiment, the reader/transmitter electronics are centralized and the required RF signals are transmitted over coaxial cables to and from selected transmitters/receivers. Tx ports may be connected to small quadrafiler antennas to produce even broader and more efficient transmission patterns than patch antennas currently used on Back scatter Reader/Transmitters. When used in this manner in previous systems, as stated earlier, some of the tag location capability was hindered. The present invention enables only one Receiver (Rx) to be activated at any one instant thus allowing greater power to be utilized than previously and providing better RF tag detection.

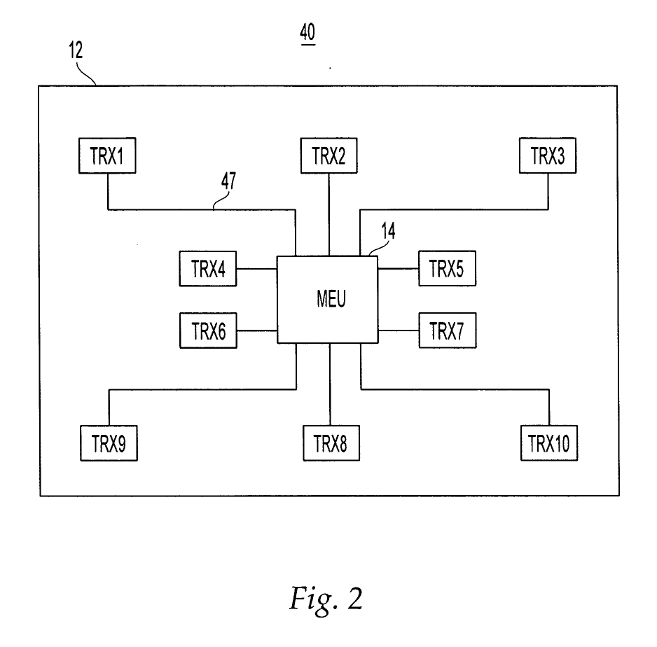

FIG. 2 is a schematic block diagram illustrating a second embodiment 40 of the invention of FIG. 1, in which the electronics control (MEU) 14 is centralized and in which the Radio Frequency (RF) is distributed to certain zones, or designated areas, in facilities to greatly reduce the expense of recurring components and to increase tag location capability. Further, the spider can be connected to AC power to eliminate cost and maintenance of batteries and to allow more read cycles, if desired. This would also permit quintupling wattage used in the transmit function, potentially increasing the size and reliability of RF signal detection zones.

In this case, the MEU 14 designates any selected TRX units with only the transmitter portion to be active. For example, the transmit portion Tx2 of unit TRX2 and the receiver portion Rx1 of TRX1 may be selected by the MEU 14 as the two transmitter/receiver units. Then, the spider would have 10 possible transmitting units and 10 possible receiving units. Again, only one Tx unit (port) and one Rx unit (port) is active at any instant. This increases the number of transmit zones and receiving zones and decreases the need for high RF power to radiate from the antenna. As stated earlier, radiating adequate power to cover large areas with only a few transmit antennas (units) results in tags being read by several receive antennas (units) and increases the difficulty in locating the RF tag. By reducing the transmitter power while increasing the number of transmitter zones, RF tag location performance similar to the battery operated reader is obtained. This system accomplishes both reduced cost while maintaining excellent RF tag location performance.

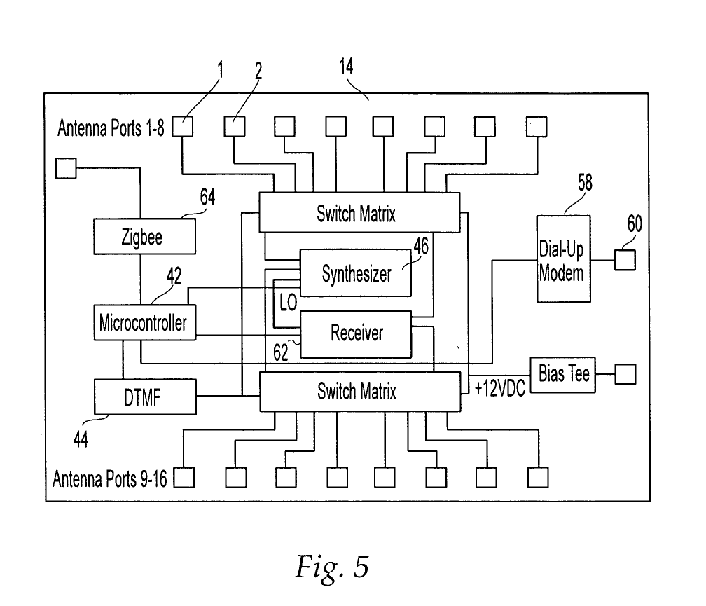

The MEU 14 spends the majority of time sleeping and wakes at programmable intervals to search for RF tags. Upon waking, the MEU 14 will scan through a programmable array of TRX antennas. For example, the MEU 14 may be programmed to start with TRX1 in the transmit mode and TRX2 in the receive mode. The microwave controller 42 (shown in the MEU 14 block diagram in FIG. 5) sends the appropriate Dual Tone MultiFrequency (DTMF) signals generated by unit 44 to port 1 and then over coaxial cable to command TRX1 to operate in the transmit mode. Next, the microcontroller 42 would send appropriate DTMF signals to port 2 and then over coaxial cable to command TRX2 to operate in receive mode. The transmitter gain is set simultaneously when TRX1 is commanded into the transmit mode.

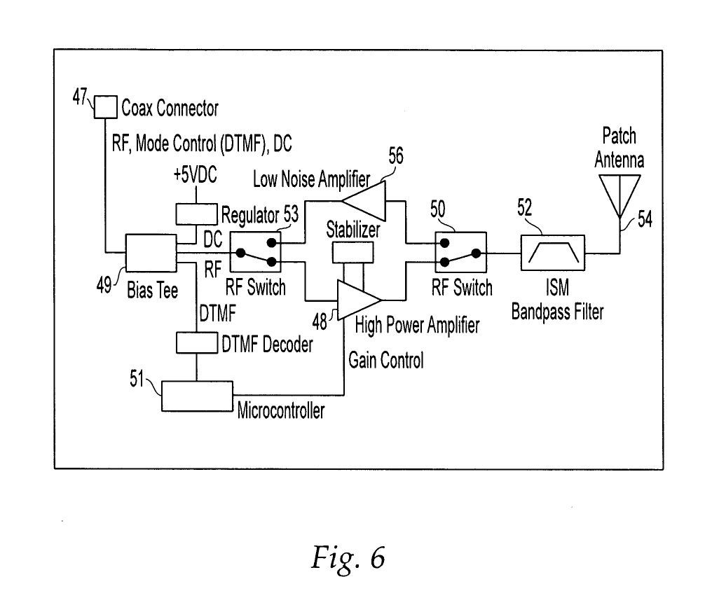

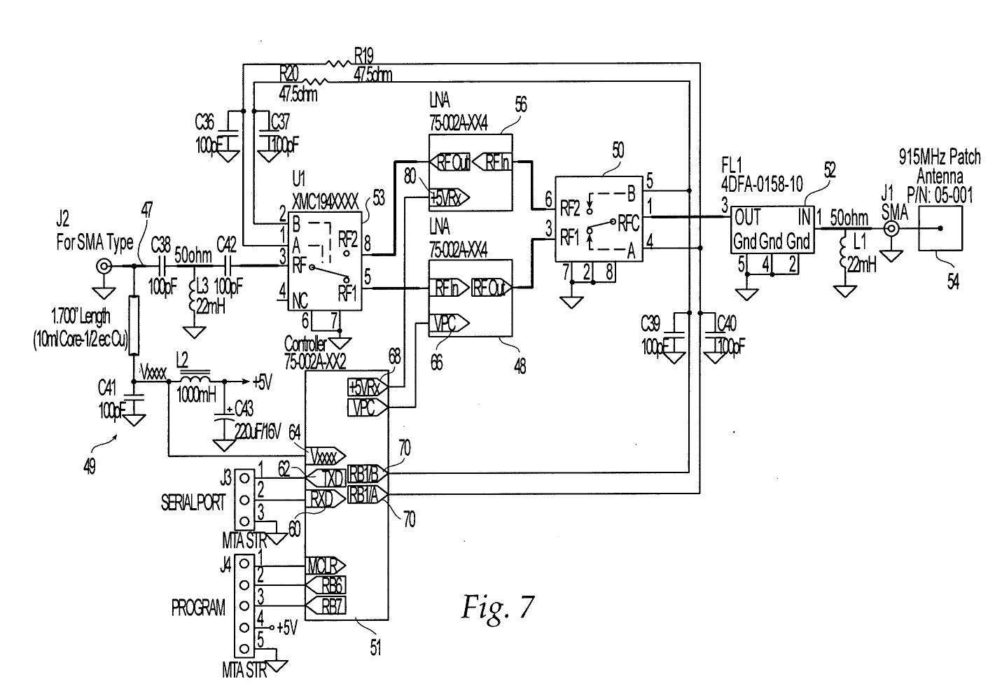

The microcontroller 42 in the MEU 14 in FIG. 5 then turns on the synthesizer 46 and loads the first frequency to be scanned in a look up table. The RF continuous wave travels to TRX 1 (in FIG. 2) over coaxial cable 47 through a bias tee 49 (see FIG. 6 and FIG. 7) and the receive portion of Transmit/Receive switch 53 to the High Power Amplifier 48 (HPA) shown in FIG. 6 where the signal is amplified. A microcontroller 52 in the TRX (see FIG. 6 and FIG. 7) controls the operations of the TRX. The signal is then passed through the transmit portion of Transmit/Receive Switch 50, ISM Bandpass Filter 52 to patch antenna 54 where the signal is radiated to RF tags in at least one given zone. Those tags programmed to receive the radiated signals respond. The receive portion of TRX2 receives the backscatter signals from the responsive RF tags that have been illuminated by TRX1. The back scatter carrier is received by patch antenna 54, (see FIG. 6) passes through the ISM filter 52 and the receive portion of TR switch 50 and is then amplified by the Low Noise Amplifier (LNA) 56. The amplified signal is sent through the transmit portion of the TR switch 53, bias tee 49, and back on coaxial cable 47 to the MEU 14. The MEU 14 demodulates the received signal and verifies the data integrity of the RF tag and transfers the demodulated signals to the microcontroller 42 (in FIG. 5). Microcontroller 42 stores the tag ID, TRX combination, transmitter power level, frequency channel, and RSSI for later transmission. The MEU 14 scans through 51 frequency channels, dwelling on each channel for approximately 300 ms.

The process is then repeated on the next transmitter power level setting through synthesizer 46 and continues until all power level settings have been cycled. The microcontroller 42 then shuts off power to the selected ports and starts on the next programmed combination of Tx and Rx units. For example, TRX3 can be set to receive and TRX 2 can be set to transmit. There are many combinations of TRX antenna modes that would only supply redundant data. Optimum combinations can be determined by field testing the invention.

The MEU 14 can be reconfigured remotely through the dial up modem 58 through access port 60. TRX combinations, transmitter power level settings, and number of scans per setting are just a few of the parameters that can be remotely configured. A remote Control Center (not shown) can poll any MEU 14 and retrieve status information about the system.

The MEU 14 is designed with a wireless transceiver 62 that uses IEEE 802.15.4 protocol with a Zigbee 64 overlay. Such overlay facilitates a broad range of interoperable consumer devices and is well known in the art and will not be discussed further here. Its use here allows “active” RF tags or sensors to report directly to the MEU 14. One such application identifies shelves and tag equipped PDQ's placed on the shelves. The identities of the RF tag equipped PDQ and shelf will be periodically transmitted to the MEU 14 from any location within the retail establishment.

One of the benefits of the present invention is the increased backscatter transmitter power. Under FCC, part 15 rules, a conducted RF output power of 1 watt is allowed. Existing BRT'S, being limited by battery power, have a maximum output power of 200 mW to “illuminate” RF tags (i.e., reflect and receive backscatter modulated signals produced by the RF tags). The conducted RF power out of the TRX antenna during the transmit mode will be increased by only approximately 100 mW over and above battery operated BRT's. Additional radiated power will be the result of improved patch antennas. The radiated power should be approximately 1W on high power. The previous units radiated 4W or +36 dBm, the maximum allowed by the FCC. As stated earlier, too much power can be a detriment when pinpointing the location of the RF tags or displays.

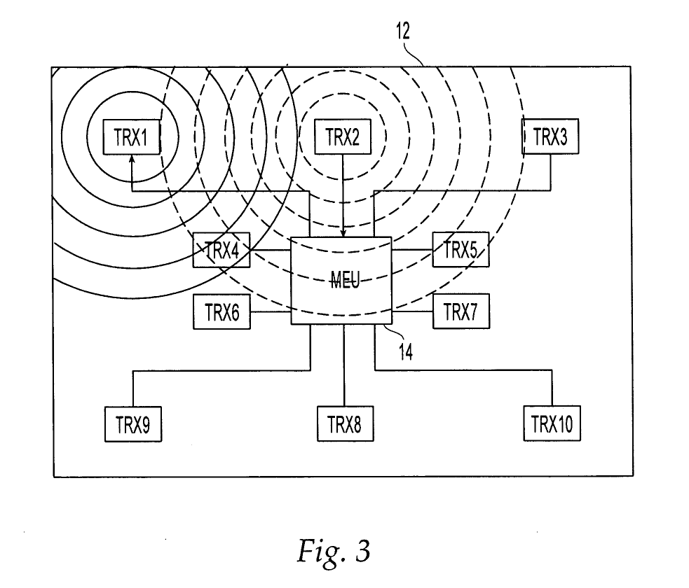

A challenge for any backscatter RF reader is the transmitter power being coupled into the receiver through the receiver antenna. The backscattered signal from the tag is extremely small, and its detection can easily be overwhelmed by the backscatter transmitter carrier wave signal. Therefore, separation of the two TRX antennas results in better performance. The illustration of antenna deployment shown in FIG. 2 and FIG. 3 allow for excellent separation. FIG. 2 operation has already been discussed.

FIG. 3 is like FIG. 2 except that in FIG. 3, TRX1 is transmitting and TRX2 is receiving.

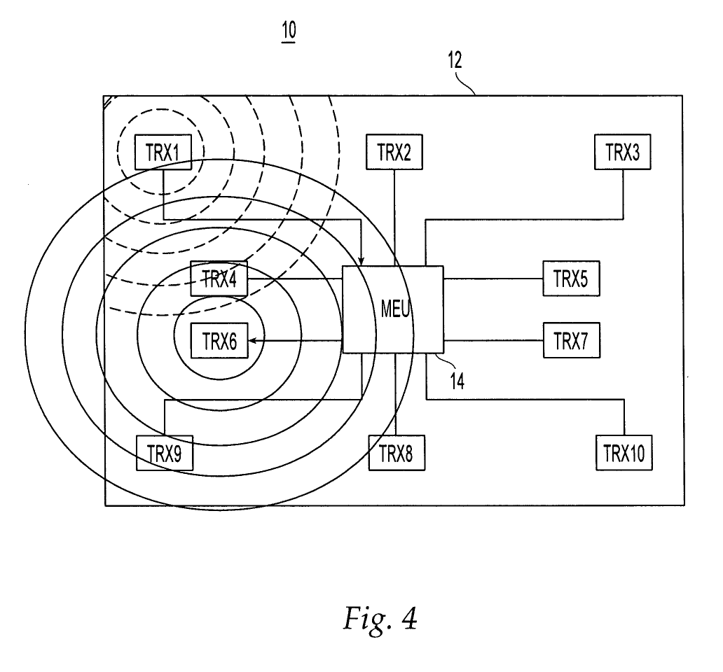

Similarly, in FIG. 4, TRX6 is transmitting and TRX1 is receiving. The numerous pair possibilities can be understood from viewing FIGS. 2, 3, and 4.

FIG. 7 is a circuit diagram of the TRX antenna shown in block diagram form in FIG. 6. The microcontroller 52 receives control signals from the MEU 14 and causes the unit to act as a transmitter or a receiver. When the unit acts as a transmitter, the input signals from the MEU 14 are coupled to bias tee 49 and through the receive portion of TR switch 53 to HPA 48 (FIG. 7). The amplified signals are then coupled to the transmit portion of TR switch 50, ISM Bandpass filter 52 and then to patch antenna 54 for transmission to the RF tags.

When the TRX shown in FIG. 7 acts as a receiver, the signals from the RF tags are received by the patch antenna 54, coupled to the ISM Bandpass filter 52, and passed through the receive portion of the TR switch 50 to the LNA (Low Noise Amplifier) 56. The amplified signal is then coupled through the transmit portion of the TR switch 53 to coaxial connector 47 for transmission to the MEU 14.

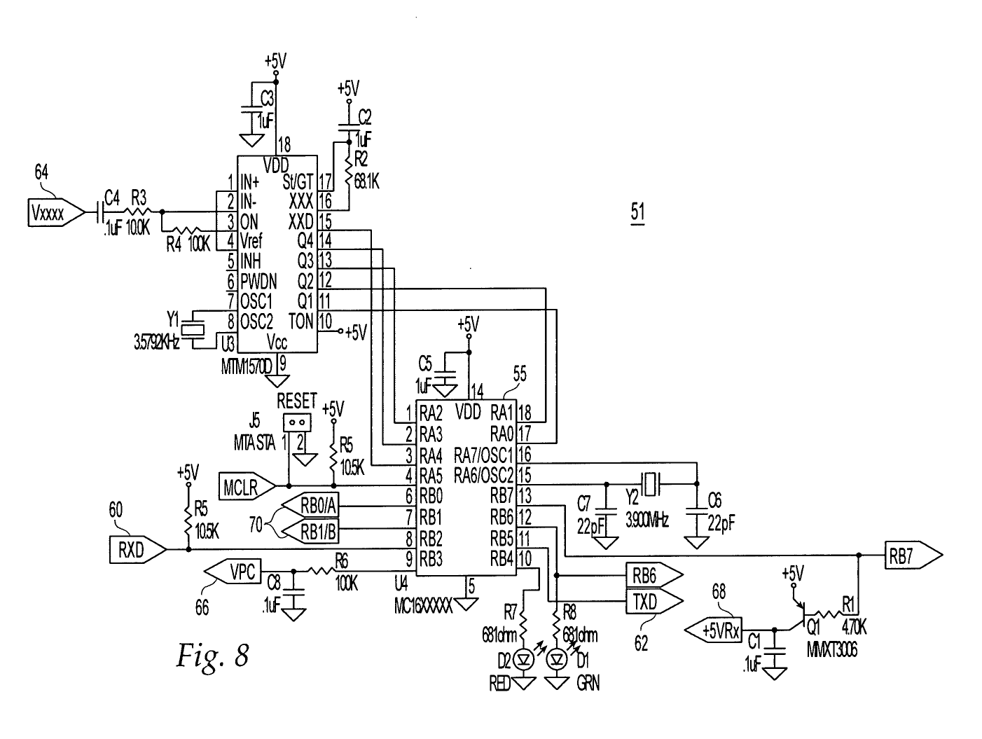

FIG. 8 illustrates the circuit diagram of the microcontroller 51 shown as part of the TRX in FIG. 7. The controller 51 is based on a PIC 55 shown as block U4 in FIG. 8. The signal from the MEU 14 to command the TRX to act as a receiver comes into the unit on connection 60. The command to the TRX to act as a transmitter comes into the unit on connection 62. Data signals from the MEU 14 are received on coaxial cable connector 64. The control signal for the HPA 48 (see FIG. 7) is generated on pin 66 and the control signal for the LNA 56 in FIG. 7 is generated on pin 68. Signals for controlling the TR switches 50 and 53 are generated on pins 70 (FIG. 8).

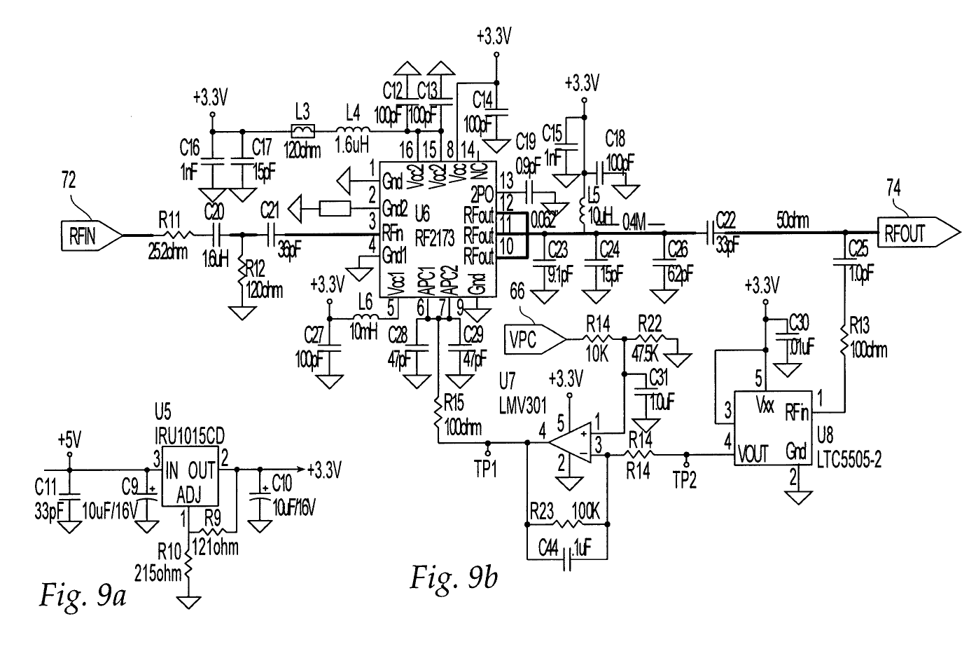

The HPA 48 is shown by electrical diagrams in FIG. 9. A power supply is shown in FIG. 9A for generating 3.3 volts for various parts of FIG. 9B. The RF signal from the MEU 14, when the unit is acting as a transmitter, is received at terminal 72, amplified, and transmitted to the TR switch 50 on terminal or connection 74. The operation of the HPA 48 is commanded by controller 51 in FIG. 7 on pin 66.

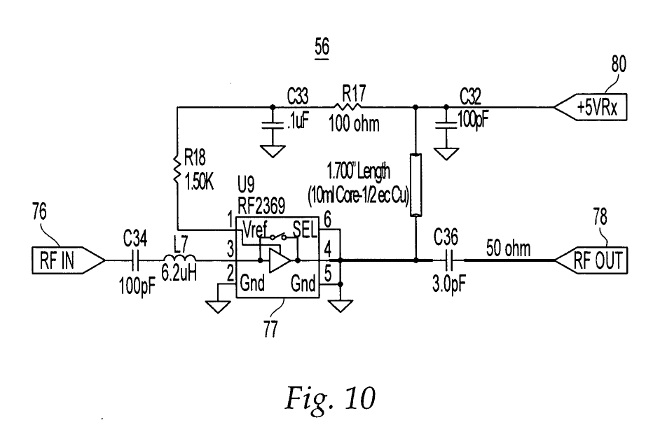

The LNA 56 is shown electrically in FIG. 10. It receives RF signals in from the receive portion of the TR switch 50 on pin 76, amplifies the signals with low noise amplifier 77 and transfers the amplified signals on pin 78 to the transmit portion of TR switch 53 for transmission to the EMU 14. The LNA 56 is enabled by a signal on pin 80 from controller 51 shown in FIG. 7.

Thus, there has been disclosed a novel improved low-cost system and method for detecting and locating merchandising materials in retail environments using RF tags.

The novel invention reduces system cost by utilizing a single BRT/Hub (Spider), also known as the Main Electronic Unit (MEU) and eliminating the need for separate Transmit and Receive Units. A TRX (transmit/receive) unit can function as either a transmitter unit or a receiver unit as selected by the MEU. The MEU selects only one transmitting unit and only one receiving unit to be active at any one time.

By having a plurality of spaced TRX units, each of which may operate as either a transmitter or a receiver, the number of transmit zones is increased, spacing between zones is decreased, and the need for high power to radiate from the transmitter units to the RF tags in a particular zone is decreased.

While particular embodiments of the invention have been shown and described in detail, it will be obvious to those skilled in the art that changes and modifications of the present invention, in its various embodiments, may be made without departing from the spirit and scope of the invention. Other elements, steps, methods, and techniques that are insubstantially different from those described herein are also within the scope of the invention. Thus, the scope of the invention should not be limited by the particular embodiments described herein but should be defined by the appended claims and equivalents thereof.

What is claimed is:

1. An improved system for monitoring objects in a facility comprising:
a plurality of RF tags dispersed in predetermined zones in a selected facility, each of the RF tags being associated with a particular object;
at least one main electronic unit (MEU) associated with the selected facility for enabling monitoring of the RF tags in all of the given zones;
a plurality of antenna ports electronically coupled to the MEU;
at least one first] transmit/receive (TRX) unit for transmitting RF signals to at last a portion of the RF tags located in at least one given zone;
at least one second TRX unit located in each given zone for receiving at least some of the RF tag responses to the transmitted RF signals;
each TRX unit being coupled to a respective one of the plurality of MEU antenna ports; and
programmable selection means associated with the MEU to command only one TRX unit to transmit interrogation signals to RF tags in one of the given zones of the selected facility and to command only one TRX unit to receive responses to the transmitted interrogation signals from the RF tags at any given instant in time and to couple the tag responses to the MEU thereby determining whether the tagged object is in the given zone in the facility.

2. The system of claim 1 wherein:
each of the TX/TR units is a single transmit/receive unit (TRX) connected to a respective MEU antenna port via coaxial cable; and
each TRX unit contains a high power amplifier to recover coaxial cable signal attenuation and a band-pass filter at the proper frequency to reduce noise and/or harmonics.

3. The system of claim 2 wherein:
transmitter gain is set simultaneously when a TRX is commanded to operate in the transmit mode.

4. The system of claim 1 wherein:
the selected establishment is a product sale facility; and
the particular object associated with each RF tag is a product display, sign, and merchandising or advertising material (“display”).

5. The system of claim 2 wherein said selection means further comprises:
a microprocessor; and
a memory and programmable device associated with the microprocessor to enable storage of program data that automatically selects successive pairs of only one TRX for transmitting interrogation signals to RF tags in a given zone and only one other TRX for receiving RF tag responses to the interrogation signals until the MEU has caused interrogation of all RF tags in all of the given zones.

6. The system of claim 1 further comprising an external AC power source coupled to the MEU to power the MEU.

7. The system of claim 2 further comprising;
a frequency hopping device associated with the MEU for scanning each successive selected pair of TRX's over a plurality of frequencies at multiple power levels.

8. The system of claim 2 further comprising:
a dial-up modem access associated with the MEU for selectively receiving remote configuration signals to enable reconfiguration of MEU variable functions among which are TRX combinations, transmitter power level settings, and number of scans per setting, or for transmitting collected tag data to a computer remote from the facility.

9. The system of claim 1 wherein the system determines that the particular object associated with each RF tag is present in a given zone in the selected establishment where a person may either see or interact with the particular object.

10. An improved method of monitoring object location in a facility comprising the steps of:
associating one of a plurality of RF backscatter tags with a corresponding one of a like plurality of particular objects in each of a number of given zones in a selected facility;
associating a transmitter/receiver unit (TRX) with each of the given zones;
providing command signals to only a selected one of the transmit/receive units in a selected given zone over a coaxial cable to cause transmission of interrogation signals to at least some RF tags in another given zone; and
determining the presence of each particular object in the other given zone by commanding only a selected one of the transmit/receive units in the other given zone to receive RF tag signals generated in response to the interrogation signals.

11. The method of claim 10 further comprising the step of amplifying the command signals to the interrogation signal transmitter unit with a high powered amplifier to recover attenuation losses in the coaxial cable.

12. The method of claim 10 further comprising the steps of:
coupling each of the transmit/receive units to a main electronics unit (MEU) by coaxial cable;
amplifying received RF tag signals in the transmit/receive unit; and
transferring the amplified RF tag signals to the MEU via the coaxial cable.

13. The method of claim 10 further comprising the steps of:
amplifying the received coaxial cable signal in each transmit/receive unit to recover signal attenuation in the coaxial cable; and
filtering the received coaxial cable signal to reduce noise and/or harmonics.

14. The method of claim 10 further comprising the steps of:
simultaneously setting transmitter gain when a transmit/receive unit is commanded to operate in the transmit mode.

15. The method of claim 10 further comprising the steps of:
choosing a product sale facility as the selected facility; and
associating at least one of a product display, sign, and merchandising or advertising material with each RF tag as the particular object whose presence is detected.

16. The method of claim 10 further comprising the step of:
successively scanning each selected pair of transmit/receive units repetitively over a plurality of frequencies and at multiple power levels.

17. The method of claim 10 further comprising the step of:
using a received signal strength indicating circuit (RSSI) in lieu of or in addition to varying transmitter power as an alternate approach to detecting RF tag location.

18. A method of using a plurality of RF backscatter tags, each of which is associated with one of a like plurality of objects in a selected facility, to determine the presence and location of the objects in the facility comprising the steps of:
placing a sufficient number of TRX (transmit/receive) units in the facility to interrogate all RF tags in the facility and to receive responses from all RF tags in the facility;
selecting only one pair of TRX units at a time, one to interrogate at least some RF tags in the facility and one to receive responses from the interrogated tags; and
successively selecting predetermined pairs of TRX units until all RF tags in the selected facility have been interrogated and a response received.

19. The method of claim 18 further comprising the steps of:
successively scanning each selected pair of TRX units with a plurality of successive signal frequencies to increase the ability to detect response signals from RF tags; and
successively scanning each selected pair of TRX units with a plurality of successive signal power levels to increase the ability to determine the location of each RF tag.

20. The method of claim 19 further including the step of:
using a received signal strength indicator (RSSI) either in addition to or in lieu of successive power levels to increase the ability to determine the location of each RF tag.

21. A system for using a plurality of RF backscatter tags, each of which is associated with one of a like plurality of objects in a selected facility, to determine the presence and location of the objects comprising:
combined transmit/receive units spaced within a facility and being of sufficient number to interrogate, and to receive responses from, all RF tags located within the facility;
a programmable device for selecting only one pair of transmit/receive units at any one time, one to interrogate at least some of the RF tags within the facility and one to receive a response from at least some of the interrogated RF tags; and
the programmable device successively selecting predetermined pairs of transmit/receive units to interrogate all RF tags within the facility and receive responses from all of the interrogated RF tags.
